(19) United States
(12) Patent Application Publication
(10) Pub. No.: US 2020/0055403 A1
(43) Pub. Date: Feb. 20, 2020

(54) High Efficiency Aerodynamic Vehcular Power System

(71) Applicant: Josiah Lamar Overstreet, Sugar Land, TX (US)

(72) Inventor: Josiah Lamar Overstreet, Sugar Land, TX (US)

(21) Appl. No.: 16/102,729

(22) Filed: Aug. 14, 2018

(51) Int. Cl. B60L 8/00; F03D 9/32; F03D 9/25; F03D 1/04

(52) U.S. Cl. CPC B60L 8/006; F03D 9/32; F05B 2240/941; F03D 1/04; F03D 9/25

(57) ABSTRACT

The invention is designed for manned and drone vehicles and utilizes the console and drive train area of an automobile. The invention relates to in-transit conservation of energy via the aerodynamic design improvement, and the in-transit generation of energy via the console wind power generation system. It relates to the cooling of rear electric motors and the thrusting of the vehicle by sending power back to the wind generation power system and includes combustion at a point past or behind the wind generator motor area. Wind is coursed completely through the vehicle via the opening at the front grill area, through the traditional console and drive train area, through a cylindrical, concentric, or other bladed generator or generators which charge the power grid, battery, or drive motors, then out through opening at the back of the vehicle. Power can also be sent back to the generator where it operates as a motor, powering the blades to thrust the vehicle forward.

### CROSS-REFERENCES TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable

### BACKGROUND OF THE INVENTION

### Field of the Invention

The present invention relates to in-transit conservation and generation of energy within a passenger or drone vehicle and the thrusting of same, and it relates to the cooling of electric motors on such vehicles.

Internal combustion engines contribute to the number of hydrocarbons in the atmosphere. They also contribute to other environmental pollution, noise, and the use of scarce resources such as fossil fuels. Fully electric vehicles (EV's) and hybrid vehicles have become increasingly desirable and available. While such alternative energy vehicles are widely accepted, prevalent, and sometimes incentivized by governments, the travel distance available per charge; the time and cost of charging an electric vehicle (including hydrocarbon impact from sourcing the electricity to charge the vehicles); the need to run a gas motor extensively to charge the battery of a hybrid vehicle; and the impractical prior art concerning wind-power-generating, electric vehicles, have hindered the progress and prevalence of hybrid and fully electric powered vehicles. Furthermore, relating to the prior art, the travel distance is largely limited by the size limitations and the electric power storage ability of the batteries. For the reasons above, there is a strong need for more efficient, practical, in-transit generation of electricity and in transit ways of charging fully electric and hybrid vehicle power systems.

### Description of the Related Art

The prior art has suggested many types of systems for in transit generation of electricity. Some use regenerative braking. Prior art has suggested mounting parts of the electric generator around axles and spinning parts of the vehicle. Prior art has suggested mounting a wind turbine or propeller and electric generator on top of a vehicle (U.S. Pat. No. 3,621,930 A), on to other outside areas of a vehicle, and within a box or short tube which is mounted to the top of a vehicle, but this is not practical, and seems to be non-existent in the marketplace. There is prior art that lets air into a vent to turn a fan that is hidden under a panel of a vehicle, and there is prior art that installs a wind generator behind and in front of the grill of a vehicle. There is also prior art that allows air from the grill area to be ducted under the vehicle (U.S. Pat. No. 5,680,032 A). (US20120049525, U.S. Pat. No. 5,986,429 A, US20040084908 A1, US20030209370, US20050046195 A1, U.S. Pat. Nos. 4,314,160 A, 4,179,007 A, US20110101698 A1, CA2695910A1, U.S. Pat. No. 5,280,827 A, 3,876,925).

No prior art has shown an air conduit tube which utilizes the vehicle console and full drive train console area (that area which fits the drive train of a traditional front combustion engine vehicle) to seamlessly pass air from the grill area (the blunt area of the front of the vehicle with the most wind resistance and drag), completely through the vehicle by passing the air straight through the grill, and then directly through the generally straight console area (which covers drive train parts on a traditional combustion vehicle) and straight out of the rear of the vehicle. This drive train console area is no longer needed in a traditional electric vehicle which utilizes motors mounted directly or closely to the back wheels, but such consoles are still very desirable to passengers. No prior art has shown such a fluid (air) conduit tube that sends air completely through a vehicle drive train console and straight out of the rear of the vehicle. Therefore, also, no prior art has shown such an air or fluid conduit tube that sends air completely through a vehicle drive train console and straight out of the rear of the vehicle in order to 1) power a generator and allow for faster charging of the vehicle, 2) allow for better aerodynamic efficiency of the vehicle, independent of utilizing a wind generator, 3) cool the electric drive motors of the vehicle, or 4) use the power generated to send power back to the generator(s) to propel said generator(s) as an electric induction motor, in order to propel the vehicle forward to achieve faster speed and acceleration.

### SUMMARY OF THE INVENTION

The present invention includes an aerodynamic improvement and wind energy charging and thrusting system for vehicles, which includes; 1) a hollow air conduit tube placed generally straight and completely through a passenger or drone vehicle, starting at the conventional grill area and through the area of the traditional console and drive train of the vehicle, opening at the rear of the vehicle, in order to allow air to pass directly through the vehicle while traveling, 2) a bladed, electric generator or plurality of generators which are placed within the tube and which are turned by the air passing through the tube when the vehicle is traveling and which charge a battery and or send power to the drive motors, 3) ancillary tubes and/or ducts which are extensions of the main tube and which allow more air to flow through the vehicle more quickly, allowing more air pressure to be relieved from the front intake area of the main tube (one or more of said tubes and or ducts may travel toward and release air upon electric drive motors of the vehicle in order to cool them for better performance and longevity, 4) one or more batteries to be charged by the generator(s), 5) circuitry to allow for systematic charging of the battery units of the vehicle and for the generator(s) to be powered to operate as electric motor(s) in order to turn the blades more rapidly to produce thrust for the vehicle.

The primary, hollow, air conduit tube structure relieves drag from the front of the vehicle by passing air longitudinally and completely through the vehicle, from an opening in the front of the vehicle to a rear opening at the rear of the vehicle. One or more smaller tube(s), duct(s), or vent(s), extend from the main tube and may be placed anywhere throughout the vehicle, in order to relieve pressure from the main tube, allowing more air to pass into the main tube, further relieving drag, which increases the in-transit aerodynamic efficiency of said vehicle.

The primary tube, other tube(s), and/or duct(s) may be fashioned with some area having a tapered, smaller bore or width, causing a “Venturi” effect, which causes air to travel faster within the narrower section of the tube or duct. The primary tube passes from the grill area through the conventional console and drive train area straight through the middle of the vehicle and releases air flow t out of the back of the vehicle.

One or more wind powered, electric generators are placed in the path of air flow that passes through the main tube or smaller tube or duct, near, at, or within, the entrance or exit of any narrower, higher speed air flow area of a tube or duct to benefit from faster air flow, or in a larger area of the tube to utilize the larger diameter for the turbine(s) or both.

The importance of this invention over the prior art is quickly understood when applying this invention to the current build of fully electric vehicles. Some hybrid and likely most fully electric vehicles (EV's) would allow for such a conduit tube to pass seamlessly and directly through the vehicle, within the traditional entire drive train and console area, from the grill area, all the way to the general license plate area at the back of the vehicle. Other hybrid vehicles can also be fitted very similarly, depending on the placement of the combustion motor(s). Even combustion motor vehicles can be designed to implement this system over flatter designed motors and transmissions.

This invention is extremely important considering, for example, that in both passenger and drone vehicles, it is extremely impractical and troublesome to mount a wind generator outside of the normal perimeters of the vehicle as prior art suggests. Furthermore, such placements would only create significantly more drag than the vehicle previously experienced. It is also not very efficient to put small fans in front of or behind the grill, where the air flow is then obstructed, or behind an intake scoop or slotted panel as prior art has also suggested. It is also impractical to pass air through the cabin space of a passenger vehicle in any other way than taught herein. The prior art uses of electric generators as described above has therefore, for the most part, been a novelty and is therefore virtually, if not totally, nonexistent in the market place, other than to power ancillary devices.

### BRIEF DESCRIPTION OF THE SEVERAL VIEWS OF THE DRAWING

FIG. 1 on sheet 1 depicts a drone or traditional, fully electric driven or hybrid vehicle fitted with the fluid/air conduit tube. FIG. 2 on sheet 1 also depicts a drone or traditional, fully electric driven or hybrid vehicle fitted with the fluid/air conduit tube.

FIG. 3 on sheet 2 depict a vehicle fitted with wind power generating turbines with horizontal and vertical shafts. FIG. 4 on sheet 2 depicts a side view of a vehicle fitted with the air conduit tube.

FIG. 5 on sheet 3 depicts the air conduit tube system with horizontal shaft generators. FIG. 6 on sheet 3 depicts the air conduit tube system fitted with vertical shaft generators.

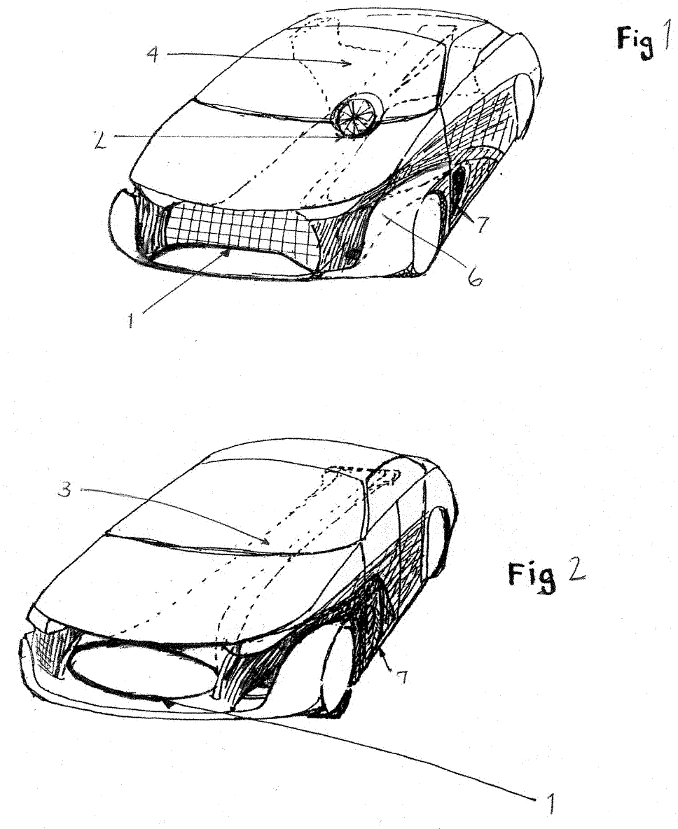

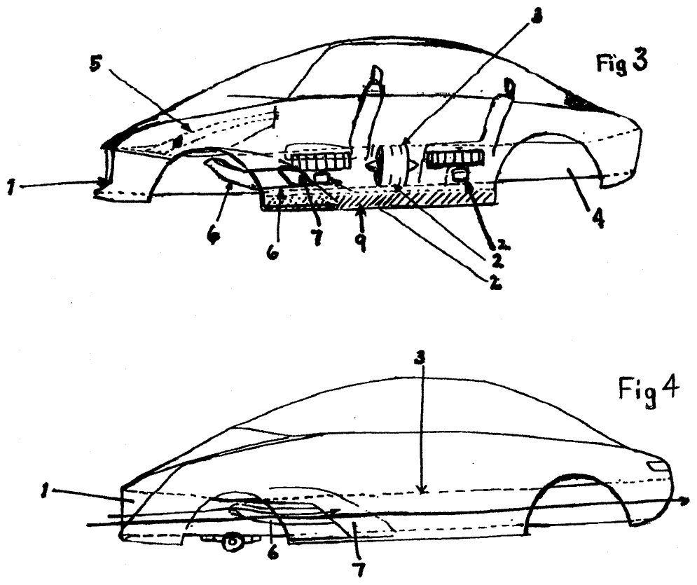

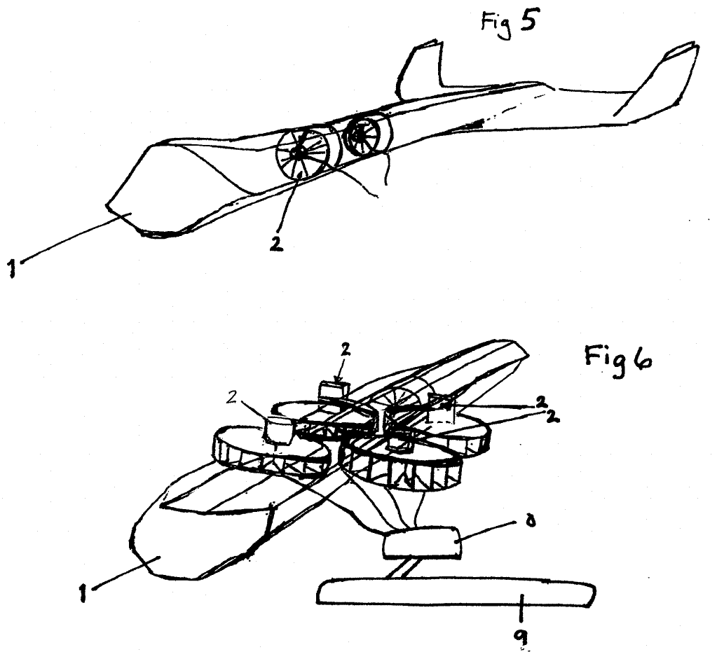

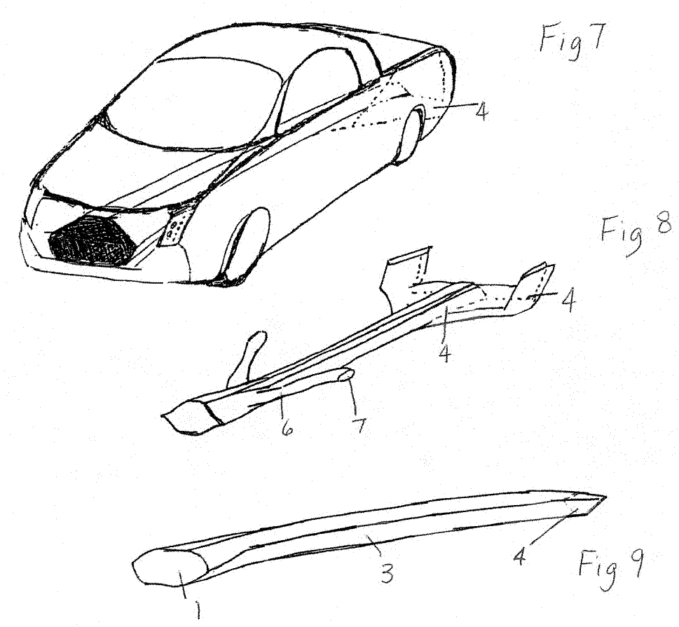

Number 7 on sheet 4 depicts the air conduit tube with a flared-out release design on the back fitted to a truck. FIG. 8 on sheet 4 depicts an air conduit tube out of a vehicle, with flared-out release area and ancillary toward the front. FIG. 9 on sheet 4 depicts an air conduit tube that is out of a vehicle and has no ancillary tubes or flared rear release area.

### DETAILED DESCRIPTION OF THE INVENTION

The present invention is designed for manned and unmanned vehicles. The purpose is to increase the distance that a vehicle can travel without stopping to refuel the energy cells, whether the source of energy be electric, gasoline or other petroleum derived element, both, or otherwise.

The presents invention includes a contoured, hollow fluid or air/wind conduit tube, or structure (the “Primary tube”), that passes longitudinally and entirely through a vehicle from an opening in the front of the vehicle to a rear opening at the rear of the vehicle, allowing some amount, and contoured to allow an optimal amount, of air to pass though the vehicle, relieving drag from the front of the vehicle and increasing the in-transit aerodynamic efficiency of said vehicle.

The unobstructed air conduit tube runs through the entire vehicle, from the conventional grill area (where a large amount of drag would otherwise take place), to the general area of the license plate at the rear. This allows a large amount of wind (which would usually cause a sizable amount of drag at the front of the vehicle) to be released in a generally straight line, directly though the vehicle, within the traditional space, within a combustion vehicle, which is taken up by the drive train and passenger console housing area that houses the traditional engine drive train, which encompasses from the area where the engine and transmission were, in the front, to the back of the vehicle where a conventional combustion drive train console houses the exhaust (and in rear wheel drive vehicles, it also houses the drive shaft that runs to the axles in the back). The air flowing through this air conduit tube powers any type of electric generator(s) along the path of the tube.

The present invention includes one or more wind powered, electric generators that are placed in the path of fluid or air flow that passes through the tube or duct, near, at, within, or away from the entrance or exit of the narrower, higher fluid/airflow-speed area of a tube or duct. This will allow for fully electric powered vehicles and partially electric powered vehicles, and potentially all passenger or drone vehicles, to charge an electric power supply during the entire time that the vehicle is moving through air, water or other fluid, which further improves the potential distance that the vehicle is able to attain.

The present invention includes one or more ancillary fluid or air conduit tube(s), vent(s) or duct(s), which can be employed in conjunction with the Primary tube, to further decrease wind resistance or drag on the vehicle with or without wind or fluid powered, electric generator(s) or turbines within any particular tube, vent, or duct. Other than the primary tube, it is not necessary for any tubes or ducts to travel longitudinally through the vehicle, in order to reduce drag or to be used to direct fluid or air to a generator or to an electric drive motor for cooling.

The system further includes output terminals, from each generator, to provide power to a power grid, battery, secondary battery or secondary battery section, battery chamber or segment, or directly to an electric drive motor of the vehicle.

The invention further includes an amplifier that is linked to the power grid or one or more generator(s) that makes use of a currently available “noise reducing”, or other sound wave cancelling computer programs, to reduce infrasonic oscillations created by any tube(s), vent(s) or duct(s) within the vehicle.

All material used to make all of the above is comprised of commonly used material in the field of the invention. There are currently suitable generators and bladed rotors, fans propellers, or turbines that are suitable to attach to the generators described herein. There are currently suitable and common metal, wires and magnetic material used in the industry to build the generators proposed herein, and there is commonly used material that is suitable to build the ducts, air-flow tubes and vents, including the primary tube, which can be reinforced with a metal, plastic, composite, carbon fiber or other rigid material.

1. An aerodynamic system for manned and unmanned vehicles comprising:
A) a fluid/air conduit tube extending longitudinally and completely through a manned or unmanned automobile, from the front grill area to the back, passing through the traditional console and drive train and/or traditional exhaust housing console area of the vehicle, through which air flows as the vehicle travels in a forward direction, and such console area may be expanded to be in the shape of an “executive console” in the front and back of the vehicle
B) One or more tubes that are ancillary to the main tube and which allow more air-flow to enter the front of the main tube, as the vehicle travels, and which may also be used to direct air to cool circuits, other electrical components, motors, brakes, or passengers or any other onboard object that could utilize coaling by dynamic air flow.
i. The invention of claim 1, comprising also one or more wind driven generators which comprise a propeller or bladed apparatus which is rotatably mounted to spin about on a horizontal or vertical rotation axis, and a generator operatively coupled to said propeller or bladed apparatus to convert mechanical rotational force or electromagnetic energy, or any other form of energy to electric energy, to power a battery, a section of a battery, a secondary battery, a power grid, or to supply power directly to the motors of the vehicle.
ii. The invention of claim 1, comprising also one or more wind driven generators which comprise a propeller or bladed apparatus which is rotatably mounted to spin about on a horizontal or vertical rotation axis, and a generator operatively coupled to said propeller or bladed apparatus to convert mechanical rotational force or electromagnetic energy, or any other form of energy to electric energy, to power a battery, a section of a battery, a secondary battery, a power grid, or to supply power directly to the motors of the vehicle, wherein the vehicle is a combustion, or hybrid vehicle and the fluid/air conduit tube is still installed generally within the drive train and/or console area, below the console housing, and passes longitudinally and completely through the vehicle and any obstructive motor, transmission and/or other drive train components, are of a design that is compressed and/or moved, and/or the console area may be enlarged such as an executive console, to accommodate said fluid/air conduit tube.
iii. The invention of claim 1, comprising also one or more wind driven generators which comprise a propeller or bladed apparatus which is rotatably mounted to spin about on a horizontal or vertical rotation axis, and a generator operatively coupled to said propeller or bladed apparatus to convert mechanical rotational force or electromagnetic energy, or any other form of energy to electric energy, to power a battery, a section of a battery, a secondary battery, a power grid, or to supply power directly to the motors of the vehicle, wherein any type of tube(s), duct(s), and/or vent(s) are placed throughout the vehicle in places where drag or wind resistance can be reduced by directing fluid or air through any body-sections, panels, or other parts of the vehicle.
iv. The invention of claim 1, comprising also one or more wind driven generators which comprise a propeller or bladed apparatus which is rotatably mounted to spin about on a horizontal or vertical rotation axis, and a generator operatively coupled to said propeller or bladed apparatus to convert mechanical rotational force or electromagnetic energy, or any other form of energy to electric energy, to power a battery, a section of a battery, a secondary battery, a power grid, or to supply power directly to the motors of the vehicle wherein, one or more wind driven electric generator(s), is situated at, near, or away from the entrance or exit of a narrowed (venturi) section of the fluid/air conduit tube, in order to send higher velocity fluid or airflow to the generator(s), for converting the flow of the faster fluid/air to electric power.
v. The invention of claim 1, comprising also one or more wind driven generators which comprise a propeller or bladed apparatus which is rotatably mounted to spin about on a horizontal or vertical rotation axis, and a generator operatively coupled to said propeller or bladed apparatus to convert mechanical rotational force or electromagnetic energy, or any other form of energy to electric energy, to power a battery, a section of a battery, a secondary battery, a power grid, or to supply power directly to the motors of the vehicle wherein a filtration grid, grill, or filter made of a strong and thin body is placed at, in, or around the entrance of the fluid/air conduit tube for intercepting airborne debris and preventing debris of a certain size from reaching the blades of any generator(s).
vi. The invention of claim 1, comprising also one or more wind driven generators which comprise a propeller or bladed apparatus which is rotatably mounted to spin about on a horizontal or vertical rotation axis, and a generator operatively coupled to said propeller or bladed apparatus to convert mechanical rotational force or electromagnetic energy, or any other form of energy to electric energy, to power a battery, a section of a battery, a secondary battery, a power grid, or to supply power directly to the motors of the vehicle, but wherein the vehicle is any passenger or drone vehicle, such as a submarine or plane, wherein the present invention is placed generally through a drivetrain or console area of such vehicle.
vii. The invention of claim 1, comprising also one or more wind driven generators which comprise a propeller or bladed apparatus which is rotatably mounted to spin about on a horizontal or vertical rotation axis, and a generator operatively coupled to said propeller or bladed apparatus to convert mechanical rotational force or electromagnetic energy, or any other form of energy to electric energy, to power a battery, a section of a battery, a secondary battery, a power grid, or to supply power directly to the motors of the vehicle, wherein similar bladed electric generators are used in both the Primary air conduit tube and any other tube(s), duct(s) or vent(s) with or without being placed in conjunction to any narrower section of a tube in order to utilize a venturi effect.
viii. The invention of claim 1, comprising also one or more wind driven generators which comprise a propeller or bladed apparatus which is rotatably mounted to spin about on a horizontal or vertical rotation axis, and a generator operatively coupled to said propeller or bladed apparatus to convert mechanical rotational force or electromagnetic energy, or any other form of energy to electric energy, to power a battery, a section of a battery, a secondary battery, a power grid, or to supply power directly to the motors of the vehicle wherein a bladed apparatus itself is made out of conductive windings to form the armature of a generator and the housing area of the air conduit tube around the bladed apparatus is fitted with or is itself a magnet whether permanent or nonpermanent in nature (to form a stator) which together form a large generator.
ix. The invention of claim 1, comprising also one or more wind driven generators which comprise a propeller or bladed apparatus which is rotatably mounted to spin about on a horizontal or vertical rotation axis, and a generator operatively coupled to said propeller or bladed apparatus to convert mechanical rotational force or electromagnetic energy, or any other form of energy to electric energy, to power a battery, a section of a battery, a secondary battery, circuitry or a power grid, or to supply power directly to the motors of the vehicle wherein a cylindrical shaped object is bladed on the front and or the back and is affixed with conductive metal windings and is placed within the air conduit tube where that area of the conduit tube is fitted with or formed to be magnetic so as to act as the stator.
x. The invention of claim 1, comprising also one or more wind driven generators which comprise a propeller or bladed apparatus which is rotatably mounted to spin about on a horizontal or vertical rotation axis, and a generator operatively coupled to said propeller or bladed apparatus to convert mechanical rotational force or electromagnetic energy, or any other form of energy to electric energy, to power a battery, a section of a battery, a secondary battery, a power grid, or to supply power directly to the motors of the vehicle wherein an infrasound reducing mechanism is employed, comprising cone shaped air flow or wind tubes and which are placed within the fluid air conduit tube structure or elsewhere in or on the vehicle to change the oscillations and cancel infrasound, mechanical or any other type of noise.

2. Concentric, cylindrical electric generator comprising:
A) A concentric cylindrical tube mounted within an area of a larger, cylindrical tube wherein the larger, outside cylindrical tube is fashioned as a stator, for example, affixed with or made out of magnets (permanent or nonpermanent) and the inside concentric, cylindrical tube is fashioned as an armature—such as with conductive metal windings around the outer or inner surface of the wall of the inner cylindrical tube. The inner tube is affixed with blades at the front and or back which causes it to rotate.
B) A concentric cylindrical tube mounted within an area of a larger, cylindrical tube wherein the larger, outside cylindrical tube is fashioned as a stator, for example, affixed with or made of magnets (permanent or nonpermanent) and the inner concentric, cylindrical tube is fashioned as an armature—such as with conductive metal windings around the outer or inner surface of the wall of the inner cylindrical tube. There is a third cylindrical tube placed within the first inner cylindrical tube that is again fashioned out of or affixed with magnetic material and both inner cylindrical tubes are affixed with blades at the front and or the back which cause the tubes to counterrotate within the outer most (initially mentioned cylindrical tube.
